(19) United States
(12) Patent Application Publication
(10) Pub. No.: US 2009/0144753 A1
(43) Pub. Date: Jun. 4, 2009

(54) Method And System For Providing Update Content In A Markup Language-Based Resource

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 11/948,067

(22) Filed: Nov. 30, 2007

(51) Int. Cl. G06F 13/00

(52) U.S. Cl. 719/318

(57) ABSTRACT

Methods, systems and computer program products are described for providing update content in a markup language-based resource. One method includes providing to a client a markup language based resource including an event element defined in the markup language. The event element identifies an event and directs the client to detect the identified event at the client in association with presenting the resource as a page by the client. The event element also includes information identifying a remote content provider for providing update content for an updatable portion of the resource. The method also includes receiving an indication that the identified event is detected in association with presenting the resource at the client, and in response to receiving the indication, providing for the identified remote content provider to provide update content for the updatable portion of the resource.

### COPYRIGHT NOTICE

A portion of the disclosure of this patent document contains material which is subject to copyright protection. The copyright owner has no objection to the facsimile reproduction by anyone of the Patent and Trademark Office patent file or records, but otherwise reserves all copyright rights whatsoever.

### BACKGROUND

Current web browsers present web pages to users by obtaining web page content from web servers and presenting a representation of the content to the users. Current web page content includes markup language elements, such as tags and attributes that the browser processes in determining how to present the content, such as text, audio, video, and image data. In addition, web page content can include executable code, known as a script that also affects the presentation of the content.

A script is set of executable instructions that is downloaded from a web server typically included in a resource, such as a web page. A script is interpreted and executed by a script engine of the web browser for performing a function, such as obtaining data for dynamically updating a presentation of an including HTML based resource and/or for enabling dynamic behavior in response to user input. For example, a script may be downloaded included in a stock quotes HTML page to periodically contact a web server to obtain updated stock quotes. Accordingly, the web page content can be updated automatically with new information.

Two examples of existing technologies that depend on scripts to provide dynamic content are dynamic HTML (DHTML) and asynchronous JavaScript and XML (AJAX). DHTML uses scripting to provide dynamic content, but does not allow a page to be updated based on a request to a server, since a response to the request causes the browser to present content included in the response in place of the requesting page. AJAX is a set of technologies enabling interactive web applications. AJAX uses a combination of XML e.g., XHTML and cascading style sheets (CSS), to describe the presentation of a document in a markup language. AJAX uses a document object model (DOM) which describes, in a tree structure, the structure of the XML document. Like DHTML, AJAX uses client-side scripting for providing dynamic web pages. AJAX script technology includes support for a script programming interface that allows a client-side script to exchange data with a server during the presentation of an associated document. The script can update the document's DOM based on data obtained from an exchange with a server. Updating the DOM allows the browser to dynamically update the presentation to reflect the updated DOM.

While scripts can enhance the user's web browsing experience, they can also pose a serious security threat. For instance, some scripts can be used for gathering information from a user's computer and returning that information to a server without authorization from the user. Other scripts can get and set cookies unrelated to the user's purpose for retrieving a web page and plant or open spyware or other malicious executables on the user's computer.

Accordingly, there exists a need for methods, systems, and computer program products for providing updated content in a markup language-based resource, such as a web page.

### SUMMARY

Methods, systems and computer program products are described for providing updated content in a markup language-based resource. One method includes providing to a client a markup language based resource including an event element defined in the markup language. The event element identifies an event and directs the client to detect the identified event at the client in association with presenting the resource as a page by the client. The event element also includes information identifying a remote content provider for providing update content for an updatable portion of the resource. The method also includes receiving an indication that the identified event is detected in association with presenting the resource at the client, and in response to receiving the indication, providing for the identified remote content provider to provide update content for the updatable portion of the resource.

In another aspect of the subject matter disclosed herein, a system for providing updated content in a markup language-based resource includes means for providing to a client a markup language based resource including an event element defined in the markup language, where the event element identifies an event and directs the client to detect the identified event at the client in association with presenting the resource as a page by the client and where the event element also includes information identifying a remote content provider for providing update content for an updatable portion of the resource. The system also includes means for receiving an indication that the identified event is detected in association with presenting the resource at the client, and means for providing for the identified remote content provider to provide update content for the updatable portion of the resource in response to receiving the indication.

In another aspect of the subject matter disclosed herein, another system for providing updated content in a markup language-based resource includes a view generator component configured for providing to a client a markup language based resource including an event element defined in the markup language, where the event element identifies an event and directs the client to detect the identified event at the client in association with presenting the resource as a page by the client and where the event element also includes information identifying a remote content provider for providing update content for an updatable portion of the resource. The system also includes an input router component configured for receiving an indication that the identified event is detected in association with presenting the resource at the client, and an event handler component configured for providing for the identified remote content provider to provide update content for the updatable portion of the resource in response to receiving the indication.

In another aspect of the subject matter disclosed herein, a computer readable medium embodying a computer program, executable by a machine, for providing updated content in a markup language based resource is disclosed. The computer program comprises executable instructions for providing to a client a markup language based resource including an event element defined in the markup language for identifying an event and including information identifying a remote content provider for providing update content for an updatable portion of the resource, the event element for directing the client to detect the identified event at the client in association with presenting the resource as a page by the client, for receiving an indication that the identified event is detected in association with presenting the resource at the client, and for providing for the identified remote content provider to provide update content for the updatable portion of the resource in response to receiving the indication.

In another aspect of the subject matter disclosed herein, a method for dynamically updating content in a markup language based resource is disclosed. The method includes detecting an event in association with presenting by a client a markup language based resource as a page where the resource includes an event element defined in the markup language for identifying the detected event. The resource includes information identifying a remote content provider for providing update content for an updatable portion of the resource in association with the detecting of the event identified by the event element. The method further includes indicating to the identified remote content provider the detection of the identified event associated with the presentation of the resource. The method still further includes receiving update content for the updatable portion of the resource from the identified remote content provider. The method also includes updating the page by updating the updatable portion of the resource with the received update content.

### BRIEF DESCRIPTION OF THE DRAWINGS

Objects and advantages of the present invention will become apparent to those skilled in the art upon reading this description in conjunction with the accompanying drawings, in which like reference numerals have been used to designate like elements, and in which:

FIG. 1 is a block diagram illustrating an exemplary system for providing updated content in a markup language based resource according to an exemplary embodiment;

FIG. 2 is a block diagram illustrating an exemplary transition device according to an exemplary embodiment;

FIG. 3 is a flowchart illustrating a method of providing updated content in a markup language based resource according to one exemplary embodiment;

FIG. 4 is a block diagram illustrating an exemplary handler component according to an exemplary embodiment;

FIG. 5 is a block diagram illustrating an exemplary system for dynamically updating content in a resource according to one embodiment;

FIG. 6 is a block diagram of an exemplary markup handler component according to an embodiment; and

FIG. 7 is a flowchart illustrating an exemplary method for dynamically updating content in the resource according to one embodiment.

### DETAILED DESCRIPTION

Methods, systems, and computer program products for providing updated content in a markup language based resource are disclosed. Typically, a “markup language” establishes a vocabulary, grammar, and syntax of codes, collectively referred to as “elements,” that provide information about a resource based on the markup language. The information provided can include, for example, information about the structure of the resource, information about the presentation of the resource, and/or information that constitutes metadata associated with the resource. A markup language can provide elements applicable to text, image, video, or other forms of data included in and/or referenced by a resource based on the markup language.

Markup language information can be specified by an element referred to as a “tag” that is recognizable by a markup language processor. For example, in XML a tag is indicated by the syntactic symbols, “<” and “>”. A tag in XML can be made up of an opening tag and a closing tag as in “<p>content</p>” where the “<p>” tag indicates a paragraph and the “</p>” indicates the end of the paragraph, where “<p>” is the opening tag and “</p>” is the closing tag. Everything between is considered to be content of the “<p>” tag. A tag in XML can have one or more attributes that modify the meaning or processing of the tag. For example, “<p id=“0001” text=“content”/>” is a “<p>” tag with two attributes. The “id” attribute provides, through an assigned value, an identifier for the tag in which it is used. The identifier in the example is “0001” and is unique for all tags used in the same resource. The “text” attribute provides an alternative mechanism for providing the tag content. The value of the “text” attribute is the paragraph and is equivalent to “<p>content</p>”. Tags, attributes, values, content, and syntactic symbols are all elements of the markup language.

A widely known and used markup language is hypertext markup language (HTML), which exists in several versions and variants. Other well-known markup languages include standard generalized markup language (SGML) from which HTML is derived, extensible markup language (XML), DocBook, MathML, scalable vector graphics (SVG), RDF, binary XML, WML, SMIL, and the like.

When presented by the client, a markup language based resource can be displayed to a user in a single application view referred to as a page: For example, an HTML based resource presented in a single web browser view, in a window or tab, is a page, whereas an HTML document including a “<FRAMESET>” and multiple “<FRAME>” elements is not a page because the HTML document is presented via multiple views in a window or a tab. Each view associated with a “<FRAME>” is a page provided the “<FRAME>” element includes no nested “<FRAME>” elements. Examples based on other markup language based resources that exhibit analogous behavior are defined as indicated by the HTML example.

According to one aspect of the subject matter described herein, the markup language based (MLB) resource includes a markup language element referred to as an event element that identifies an event to be detected while the MLB resource is being presented as a page by a client in a client device. The event element may be any suitable markup language element, such as a tag or an attribute of a tag. An event element that is implemented as a tag, in one aspect, may be an HTML tag, an XML tag, or a tag defined in another suitable markup language. An event element that is implemented as an attribute, in another aspect, may be an HTML attribute, an XML attribute, or any attribute defined in another suitable markup language. In addition to the event element, the resource also includes information identifying a remote content provider (RCP) that can provide content for an updatable portion of the MLB resource.

In one aspect, the client is configured for processing the event element. The client is further configured for detecting an event identified by the processing of the event element while the resource is being presented as a page by the client. The client is configured to notify a remote content provider of the detection of the identified event. When the notification is received by the remote content provider, the remote content provider is configured to provide update content to the client. The client updates a portion of the MLB resource based on the received update content.

According to aspects of the subject matter described herein, a client can be configured to detect an event defined by event model associated with a presented resource, to transmit the detected event to a remote content provider such as a web service for processing, to receive a response, and to update the MLB resource based on the response. The client configured as such allows for the creation and presentation of a resource with dynamic content without the use of client-side scripting. Because client-side scripting is not used, the security threats associated with such use are eliminated.

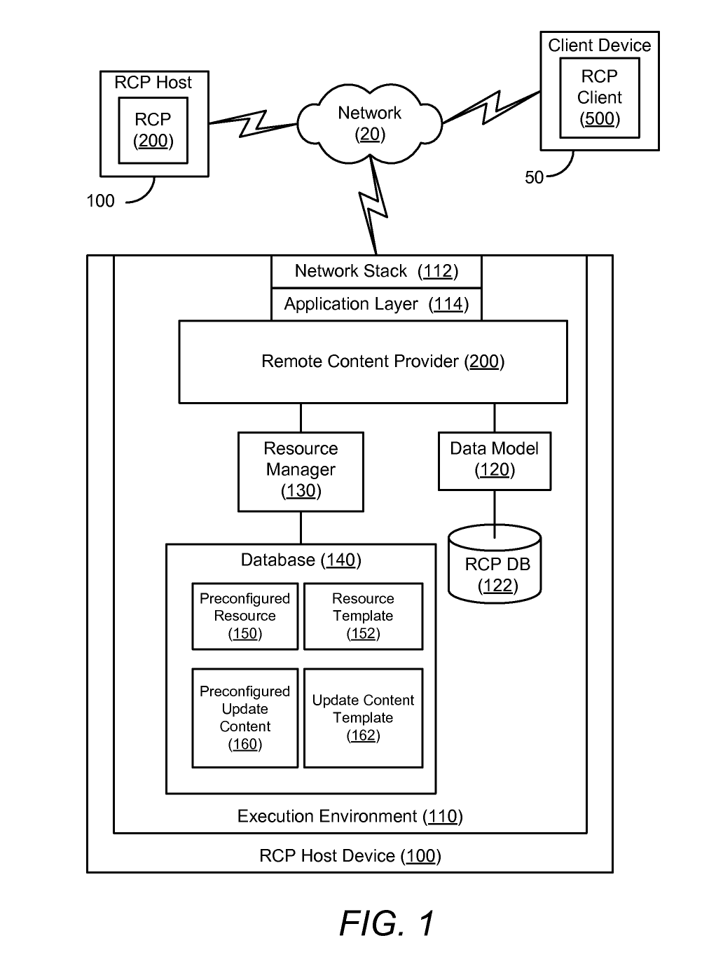

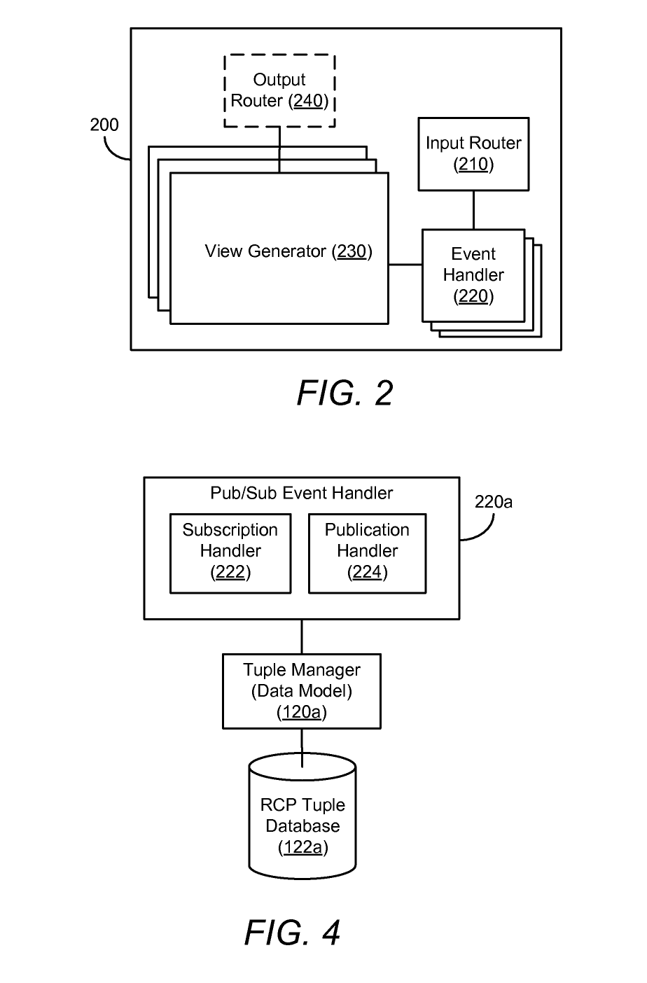

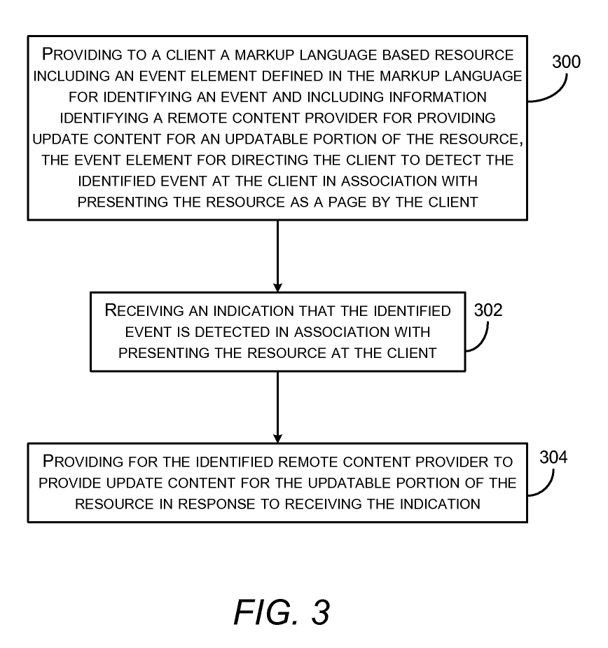

To describe in more detail the methods and systems for providing updated content in a markup language based resource, please refer to FIG. 1, which is a block diagram illustrating an exemplary arrangement according to one aspect, FIG. 2, which is a block diagram of an exemplary remote content provider according to one aspect, and FIG. 3, which is a flowchart illustrating an exemplary method for providing updated content from a perspective of a remote content provider according to one aspect. Referring first to FIG. 1, a client device 50 is illustrated communicatively coupled via a network 20 to a remote content provider (RCP) host device 100 that includes an RCP 200. In one aspect, the client device 50 includes an RCP client 500 for requesting, receiving and presenting a markup language based (MLB) resource from the RCP 200 over the network 20. The network 20 can be a Local Area Network (LAN) and/or a Wide Area Network (WAN) including the Internet. A variety of network and/or application protocols can be used by the RCP client 500 and by the RCP 200 to communicate over the network 20. For example, when RCP 200 is a web server and the RCP client 500 is a web browser, the RCP 200 and the RCP client 500 can communicate using the HTTP application protocol, and the network 20 can be a TCP/IP network, such as the Internet.

The RCP host device 100 can be any device that includes an execution environment configured to host the operation of the RCP 200. An exemplary execution environment 110 includes a processor memory for storing instructions and data of the RCP 200, a processor for accessing instructions and data in the processor memory for processing, a network subsystem for communication over a network, a file system and accessible persistent storage for storing data and instructions when not needed for processing, and an operating system for managing various hardware and software components required for hosting and operating the RCP 200 in the device 100. Exemplary RCP host devices 100 can include desktop computers, servers, notebook computers, PDAs, mobile phones, and digital image capture devices. In an aspect, the RCP 200 is configured to generate, manage, and store MLB resources and to provide MLB resources to clients 500.

According to FIG. 3, the exemplary method begins by providing to a client 500 an MLB resource including an event element defined in the markup language for identifying an event and including information identifying a remote content provider for providing update content for an updatable portion of the resource (block 300). In one aspect, the event element directs the client 500 to detect the identified event at the client 500 in association with presenting the resource as a page by the client 500. An exemplary system for carrying out the method includes means for providing the MLB resource. For example, a view generator component 230 in the RCP 200 can be configured to perform this function.

In one aspect, the RCP 200 includes an input router component 210 configured to receive a request for an MLB resource from the RCP client 500 over the network 20 via the network stack 112. Depending on the protocol used, one or more application layer components 114 can be included in the execution environment 110 and operatively coupled to the network stack 112. The application layer 114 can receive the request formatted in an application layer protocol format such as HTTP. The request can be received by the input router component 210 from the application layer 114 based on processing of application layer data by the application layer 114.

As is shown in FIG. 2, the RCP 200 includes one or more event handler components 220 and a view generator component 230. In one aspect, the input router component 210 can route the request to one or more event handlers 220 based on information in the request. The request can include, in one aspect, information identifying the MLB resource, such as a URI or a portion of a URI. The event handler 220 receiving the information from the input router component 210 can perform message specific processing and/or standard processing shared for processing message information. In one aspect, the event handler 220 can provide the information identifying the MLB resource to the view generator 230 for further processing described below.

Alternatively, the event handler 220 can call a data model 120 providing information based on the received message, such as the resource identifier, parameters included in the request, information about the sender of the message determined from the message and/or the network connection over which the message was received. The data model 120 can generate data and/or retrieve data stored in an RCP database 122. Data in the RCP database 122 can be updated as a result of processing of the data model 120. That is, data can be replaced, added, created, and/or deleted depending on the requirements of each specific update operation. The data model 120 can return data to the event handler 220 for use in retrieving and/or generating the requested MLB resource.

In another aspect, the event handler 220 can be configured for processing a message formatted using a publish-subscribe protocol. FIG. 4 is a block diagram of an exemplary pub-sub event handler 220a, which can be invoked in response to the input router component 210 receiving a message formatted according to a publish-subscribe protocol, such as the presence protocol portions of XMPP-IM and SIP SIMPLE. The pub-sub event handler 220a can include a subscription handler 222 configured to process a subscribe message and to manage subscriptions to tuples stored in an RCP tuple database 122a. The tuple database 122a can be managed by a data model referred to as a tuple manager 120a. The subscription handler 222 maintains subscription information and accesses tuple information via the tuple manager 120a. The pub-sub event handler 220a can also include a publication handler 224 configured to process a publish message and to update a tuple identified by the publish message. Both subscribe messages and publish messages can cause the subscription handler 222 and the publication handler 224, respectively, to call the view generator 230 for generating the MLB resource.

According to one aspect, the event handler 220 can provide data provided by the data model 120, determined by the event handler 220, and/or derived from message information to the view generator 230 depending on the specific message received and the configuration of the event handler 220 invoked to process the message. The view generator 230 can be configured to generate the requested resource based on the data provided by the event handler 220.

In one aspect, the view generator 230 can retrieve a preconfigured resource 150 and/or a resource template 152 based on the information, e.g., the resource identifier, provided by the event handler 220. The preconfigured resources 150 and resource templates 152 can be stored in a persistent data store, such as a database 140, and the view generator 230 can retrieve preconfigured resources 150 and templates 152 by invoking a resource manager 130 operatively coupled to the database 140 and configured for managing and controlling access to the database 140.

In one aspect, a preconfigured resource 150 can include an event element that identifies one or more events defined in an event model associated with at least a portion of the resource 150. Alternatively or additionally, the view generator component 230 can provide for including an event element in the resource 150. Similarly, a resource template 152 can include a preconfigured event element and/or the view generator 230 can provide for including an event element in the MLB resource generated based on the template 152. For example, the view generator 230 can invoke a script engine (not shown) to process instructions in the template 152 to include an event element in the generated MLB resource. The instructions can be external and/or included in the template 152. Data provided to the view generator 230 can also be provided to the script engine as variable data and/or parameter data for generating the resource based on the template 152.

According to one aspect, the event element included in the preconfigured resource 150 and/or generated resource is for directing a receiving RCP client 500 to detect the identified event in association with presenting the MLB resource as a page by the client 500. The event element can be further defined to direct the RCP client 500 to process the identified and detected event in a certain manner. For example, in one aspect, in response to detecting an identified event, the RCP client 500 the event element can be defined to direct the RCP client 500 to retrieve update content from an RCP 200 identified in the MLB resource. In another example, the RCP client 500 can detect an indication to send multiple messages to one or more identified RCPs 200 for receiving update content.

In another example, when the RCP client 500 is implemented including a pub-sub service, the client 500 can be configured to establish a subscription on behalf of an RCP 200 identified in the MLB resource. In this case, the identified RCP 200 can be implemented including a pub-sub client. The input router component 210 can be configured as a watcher component and the event handler 220 can be configured as a watcher user agent for processing an asynchronous message including a notification from the client 500 pursuant to the established subscription. Alternatively or additionally, the RCP client 500 can be configured for including a pub-sub client, the client 500 can be configured to send a subscription request for establishing a subscription for the client to an RCP 200 identified in the MLB resource. In this case, the identified RCP 200 can include a pub-sub service, for example, as depicted in FIG. 4. The input router component 210 can be configured to route the subscription request to the event handler 220a. The event handler component 220a can be configured as a subscription handler 222 for processing the subscription request from the client 500 for establishing a subscription for the client 500

According to an aspect, the MLB resource includes information identifying an RCP 200 for providing update content as mentioned above. The identifying information can be preconfigured in a preconfigured resource 150 or in a template 152, or can be included in the generated resource as a result of processing by the view generator 230. In one aspect, the identified RCP 200 can be the provider of the resource, while in another aspect; the identified RCP 200 can be another provider other than the provider of the presented resource. The information in the resource identifying the RCP 200 can be in any form that allows the RCP client 500 to access the RCP 200. For example, a URI or a portion of a URI can be included in the resource for identifying the RCP 200 for providing update content.

In one aspect, any existing element in a markup language can be defined as an event element. For example, the “<html>” element in HTML can be defined as an event element. When included in an MLB resource without an explicit event identifier, one or more default event identifiers can be predefined. The client 500 can be configured to detect the “<html>” element and to determine one or more pre-specified events identified by a default setting. Similarly, when an explicit RCP 200 identifier is not included, a default can be pre-specified. For example, the default RCP 200 can be the provider of the MLB resource or an RCP 200 can be identified based on a characteristic of the resource as configured in the client 500. In one aspect, multiple existing elements in a markup language can be pre-specified as event elements, and each event element can be preconfigured to identify one or more events.

For instance, in Example 1 below, the markup language represents an HTML based resource with no new HTML elements for identifying an event for detecting by the client 500. At least a portion of the tags can be associated with one or more default identifiers. For instance, all tags can, by a default specification, identify at least a portion of events of an event model associated with the resource and/or markup language. The event model can also be identified by a default specification. A default can be established by a standards body or other group and supported by a client 500 and an RCP 200. Alternatively, a default can be configured on a client 500/RCP 200 basis or for a group of clients/RCPs.

### EXAMPLE 1

Document URL=http://www.example.com/helloWorld

```
<!doctype HTML PUBLIC “-//W3C//DTD HTML 4.01//EN”
    “http://www.w3.org/TR/htmlX/strict.dtd”>
<html>
  <head>
    <title>My first HTML document</TITLE>
  </head>
  <body>
    <p>Hello world!</p>
  </body>
  </handler>
</html>
```

The document object model (DOM) level 2 event model specification published by the World Wide Web Consortium (W3C) as defined for browsers and supported currently by some scripting languages, defines an event model that can be supported by a client and associated with a HTML based resource and/or any XML based resource. An event, such as an “onClick” event, of the DOM event model can be specified as an identified default event associated with an HTML tag or tags, such as a “<p>” tag. In this example, the detecting of the “<p>” tag directs the client 500 to detect an “onClick” event in correspondence with a presented representation of the “<p>” tag and its content. Those skilled in the art will appreciate that any element of any markup language can be specified as an event element in addition to or instead of a tag element. An event element can apply to the event element itself and/or all of the event element's content according to a particular configuration.

In Example 1 above, by a default specification, the RCP 200 for providing update content associated with the identified “onClick” event can be specified as the provider of the resource, www.example.com. By default specification, the access protocol can be specified as HTTP. Other default settings can be configured as those skilled in the art will understand.

Alternatively or in addition, a markup language specification can be extended to include one or more new markup elements as event elements. For instance, in Example 2 below, the markup language represents an HTML based resource including an exemplary element, “<event>”. The “<event>” tag can be defined as an extension of HTML and/or can be defined in a different XML markup language. When defined in a different markup language, the “<event>” tag can be included in an HTML based resource by specifying namespaces for the different markup languages. Namespaces can be specified using namespace qualifiers, for example as defined in the W3C “Namespaces in XML 1.0” (second edition). The “<event>” element can be defined to specify that it and its content are associated with one or more identified events.

### EXAMPLE 2

Document URL=http://www.no.net/helloWorld

```
<!doctype HTML PUBLIC “-//W3C//DTD HTML 4.01//EN”
    “http://www.w3.org/TR/htmlX/strict.dtd”>
<html>
  <head>
      <title>My first HTML document</TITLE>
  </head>
  <event id=“e1” eid=“MouseOut” rcp=“pub-
  sub://helloWorld@no.us/body”>
  <body>
      <p id=“p1”>Hello world!</p>
  </body>
  </event>
</html>
```

Detecting an “<event>” tag in a resource can direct the client 500 to detect the identified event or events at the client 500 in association with the presentation of a portion of the presented resource 500 associated with the “<event>” tag. As discussed above, an “<event>” tag can identify an event or events based on a pre-defined default.

Alternatively or in additional, an “<event>” tag can include attributes providing an indication to the client 500 and/or an RCP 200 regarding the processing of an identified event detected in association with the tag. Example attributes include “eid”; “rcp”; “location”; and “operation” with values “insertAfter”, “insertBefore”, “delete”, or “replace”. The “eid” attribute can be associated with one or more event identifiers of events to be detected. The “rcp” attribute can be associated with an RCP identifier, such as a URL of a network service. The “operation” attribute can indicate what the client 500 is to do with received update content, and the “location” attribute can be assigned an identifier of a portion of and/or location in the markup language resource where the operation using the update content is to be performed. Both the “operation” and the “location” attributes can also be assigned by the RCP 200.

The client 500 can be configured to override client attributes with server attributes or vice versa. A default operation can be specified. For example, “replace” can be configured as the default attribute. Similarly, a default location can be specified for occasions when a “location” attribute is unspecified by the resource and unspecified by a message including the update content.

The RCP 200 is typically a remote provider accessible via a network 20. For example, the RCP 200 can be a presence service, a resource/application service, or a web service. The access protocol for communicating with the identified RCP 200 can be any number of existing protocols or protocols yet to be defined. Examples of suitable existing protocols include HTTP, FTP, SOAP and other request-response protocols, and publish-subscribe protocols such as the Jabber Foundation's protocol specified in the XMPP Standards Foundation's XEP-0060: Publish-Subscribe, and any presence protocol as specified by the IETF's RFC 2778 (Day et al., titled “A Model for Presence and Instant Messaging” (February 2000)) and RFC 2779 (Day et al., titled “Instant Messaging/Presence Protocol” (February 2000)), such as the presence protocol portion of XMPP-IM and/or SIP-SIMPLE. In another aspect, the RCP 200 can be local such as a web service running on the same machine as a browser client 500.

In Example 2 above, the “<event>” element includes an HTML “<body>” tag and its content. The “<event>” element directs a receiving client 500 to detect the identified event in association with presenting the resource as a page. An “rcp” attribute can be included the “<event>” tag for identifying an RCP 200 accessible via the URL value of the “rcp” attribute. In this case, the URL scheme indicates a publish-subscribe access protocol. Accordingly, a subscription message is to be sent in response to detecting an identified event. The “eid” attribute can be included for identifying the event to be detected by the client. In Example 2, the “eid” value is “MouseOut”. “MouseOut” can be defined to identify an event that is associated with a mouse pointer (or analog) detected moving out of a presentation area included in the presentation of the portion of the resource associated with the “<body>” tag. The “MouseOut” value can be defined for directing the client 500 to detect the moving of the pointer out of the specified presentation region. In response, the client 500 is to send a subscription message to the RCP 200 identified by the URL according to the event element specification. One or more notification messages can be sent by the RCP 200 including update content for replacing the “<body>” tag and content.

In an alternative implementation, rather than using a markup language tag to identify an event, the event element can be an attribute of a tag. For instance, in Example 3 below, an “eid” attribute can be defined to be a valid attribute for any tag element. A value of the “eid” attribute can identify one or more events to be detected by the client. Similarly, an “rcp” attribute can identify the RCP 200, as is described in Example 2, but is associated with the “eid” attribute.

### EXAMPLE 3

Document URL=pub-sub://helloWorld@no.net

| <!doctype HTML PUBLIC “-//W3C//DTD HTML 4.01//EN” | |
|---|---|
| “http://www.w3.org/TR/htmlX/strict.dtd”> | |
| <html> | |
| <head> | |
| <title>My first HTML document</TITLE> | |
| </head> | |
| <body | eid=“mouseout” |
| | rcp=“pub-sub://helloWorld@no.us/body”> |

```
    <p>Hello world!</p>
  </body>
</html>
```

In another alternative implementation, the markup language based resource can include a markup language element identifying an alternative RCP 200 from which update content can be provided for an updatable portion of the resource. Example 4 represents the specification of an alternative content provider in the markup language based resource:

### EXAMPLE 4

Document URL=http://www.no.net/helloWorld.html

| <!doctype HTML PUBLIC “-//W3C//DTD HTML 4.01//EN” | |
|---|---|
| “http://www.w3.org/TR/htmlX/strict.dtd”> | |
| <html> | |
| <head> | |
| <title>My first HTML document</TITLE> | |
| </head> | |
| <event | rcp=“pub-sub://helloWorld@no.net/body” |
| | eid=“select” |
| | altrcp=“http://no.net/helloWord/body” |
| | altTimer=“10s”> |

```
  <body>
    <p>Hello world!</p>
  </body>
  </event>
</html>
```

An “altrcp” attribute can be defined for identifying the alternative RCP 200. The alternative or backup RCP 200 can be contacted when the RCP 200 identified in the “rcp” attribute is not accessible and/or when the client 500 does not support the access protocol of the RCP 200 identified in the “rcp” attribute. An “altTimer” attribute can be defined for providing a time period for determining responsiveness of the RCP 200 identified by the “rcp” attribute.

In another aspect, the MLB resource and/or update content for updating the MLB resource can be sent to a client 500 using a pub-sub protocol in response to a message including a subscribe command addressed to the depicted URL. A portion of an MLB resource is depicted in Example 5:

### EXAMPLE 5

URL=pub-sub://somedoc@no.net/eventList

<event id=“aList”>
<ul>
<li>Unordered information. </li>
<li>Ordered information. ,/li>
<li>Definitions. </li>
</ul>
</event>

The “<event>” attribute directs the receiving client 500 to detect a default event and to send a message in response to detecting a default event to a default RCP 200. In Example 5, the default RCP 200 can be the provider of the resource that includes the portion in Example 5. When a subscription or get/fetch message is sent in response to detecting a default event associated with presenting the portion in Example 5, the message sent to the RCP 200 can include an identifier of the associated event element. The element can be identified by an XPath expression specifying the event element's position or path in the including resource. Alternatively, Example 5 illustrates a method in which an identifier, “aList”, specified by an “id” attribute can be included in the message to identify the event element to the default RCP 200.

In yet another implementation, an MLB resource can include a tag for specifying one or more attributes for a plurality of event elements and content included in the element. A portion of the MLB resource is depicted in Example 6:

### EXAMPLE 6

```
<event eid=”onLoad” rcp=” pub-sub://randomsource@no.net”/food/fruit>
<eventregion idPrefix=”tuple/prices” eid=”onNotify”
onEvent=”replace,match” >
<table border=“1”
    summary=“This table prices of fruit in our store.”>
<CAPTION><EM>Current Fruit Prices</EM></CAPTION>
<TR><TH>Fruit</TH><TH>Price</TH></TR>
<TR><TD>Apples</TD>
    <event id=”apple”><TD>$0.99 per lb</TD></event>
</TR>
<TR><TD>Oranges</TD>
    <event id=”orange”><TD>3 for $2</TD></event>
</TR>
<TR><TD>Bananas</TD>
    <event id=”banana”><TD>$0.49 per lb</TD></event>
</TR>
<eventregion idPrefix=“/exotic”>
<TR><TD>Star Fruit</TD>
    <event id=”star”><TD>$2 each</TD></event>
</TR>
</eventregion>
</table>
</eventregion>
```

As illustrated, an “<eventregion>” tag can be defined for specifying attributes for “<event>” event elements included with the “<eventregion>” element. In Example 6 an “<event>” element with an “on Load” event identifier is defined for directing the client 500 to send a subscribe command to the indicated “rcp” URL, when the resource including Example 6 is loaded by the client 500. In response to the subscription, the RCP 200 including a publish-subscribe service can send a notification to the client when a tuple identified by “pub-sub://randomsource@no.net/food/fruit” is updated. The “<eventregion>” element in Example 6, includes an event identifier with an “onNotify” value. The “onNotify” value can be defined for directing the client 500 to detect a received notification in association with presenting the resource. An “onEvent” attribute can be defined for directing the client to apply update content in the received notify message as specified by a value assigned to the “onEvent” attribute.

For example, in Example 6 the “onEvent” attribute is assigned a value pair including “replace” and “match”. The “replace” portion of the value can be defined for directing the client 500 to replace the content of an associated “<event>>” element. The “match” portion of the value can be defined for directing the client 500 to identify a portion of the update content that matches a value of an “id” attribute of an associated “<event>” element.

The tuple identified by the subscription can include a “<price>” subtuple that includes tuple elements corresponding to various items where each tuple element includes a price. A first “<eventregion>” element includes an “idprefix” assigned a value “tuple/prices” defined for directing the client 500 to prepend the “idprefix” value to all “id” values in “<event>” elements included in the first “<eventregion>” element. A tuple element with path identifier “prices/apple” can be defined for including a current price for an apple. Similar subtuples for oranges and bananas can be defined. The prices subtuple can include a further subtuple for “exotic” fruit such as starfruit identified by a “<star>” element.

In Example 6, the path identifier in the tuple for the price of star fruit is “tuple/prices/exotic/star”. An element “idprefix” can be specified in a second “<eventregion>” element included in the first “<eventregion>” element as illustrated that applies to the any included “<event>” elements. The prefix value is prepended to the value of an id attribute for all “<event>” elements included in the second “<eventregion>” element prior to prepending the “idprefix” value of the first “<eventregion>” element.

A notification can be received with tuple information including prices for a variety of items. If a tuple with a path identifier matching “prices/apple” is included, the client 500 is configured for replacing the content of the “<event>” element that includes markup for presenting the price of an apple with a corresponding portion of the tuple information included in the notification. Updates for oranges, bananas, and starfruit operate similarly. Other portions of a received tuple can be ignored by the client 500.

The first “<eventregion>” element relieves the resource developer from having to repeat the “eid” and “on Event” attributes for every included “<event>” element. The first “<eventregion>” element further specifies a “tuple/prices” prefix is to be prepended to “id” element values for included “<event>” elements. The second “<eventregion>” element allows the resource developer to include additional exotic fruit prices in the presentation without having to specify the element identifier prefix “exotic” for each included “<event>” element.

An “on Response” event identifier can be defined for processing messages from an RCP 200 including a response to a message sent by the client 500 associated with the presented resource.

An “<event>” element included in the “<eventregion>” element can override an attribute setting in the “<eventregion>” element by including a setting for the attribute within the “<event>” element. The scope of an “<eventregion>” element, in Example 6, conforms to XML rules when in XML based resources. That is, its scope is limited to its contents as specified by its begin and end tags. An “<eventregion>” can include any attribute and value associated with an “<event>” element. Setting a value for an attribute using an “<eventregion>” element is similar to setting a value for the “rcp” attribute. The use of the “rcp” attribute described is exemplary. That is, an “<eventregion>” element does not require the specification of an “rcp” attribute value.

In one aspect, when an “<eventregion>” element is detect within one or more containing “<eventregion>” elements with an attribute matching one or more of the containing “<eventregion>” elements, the value specified in the contained element for the attribute becomes the default value for the scope of the contained “<eventregion>” element. Once the contained “<eventregion>” scope is exited, the default value in effect prior to entering the contained “<eventregion>” scope becomes the default for the attribute again. In one aspect, attribute values specified by the containing “<eventregion>” elements which are not specified by a contained “<eventregion>” element remain default values.

Examples 6 illustrates an “onNotify” value for the “eid” attribute of the element with an id value of “T1001”. The “onNotify” value can be defined to identify an event including the receiving of a message including a publish-subscribe notify command by the RCP client 500. The event detected in correspondence with presenting by the RCP client 500 a resource specifying “onNotify” as an attribute value of an “eid” attribute The “onNotify” event can be associated with a portion of a presentation of a resource. A received notify command can include id identifying an element associated with the notify command. An element in the resource with a matching id is identified as specifying a location and/or portion of the resource associated with the detected event The rcp attribute value in the example can be defined to specify a tuple ID for sending a subscription request for receiving the notify command.

In another implementation, the MLB resource can be provided in any suitable markup language. For instance, Example 7 depicts an XML User Interface Language (XUL) resource:

### EXAMPLE 7

```
<?xml version=“1.0”?>
<?xml-stylesheet href=“chrome://global/skin/” type=“text/css”?>
<window id=“mouse_xy” title=“Mouse Position”
    eid=“onmousemove” path=“adjustCoords”
    properties=“event.clientX, event.clientY”
xmlns=“http://www.mozilla.org/keymaster/gatekeeper/there.is.only.xul”>
<label id=“pos” value=“ ”/>
<hbox>
  <label value=“Enter some text:”/><textbox/>
  <button label=“OK”/>
</hbox>
<listbox>
  <listitem label=“Document”/>
  <listitem label=“Image”/>
  <listitem label=“Video”/>
  <listitem label=“Audio”/>
</listbox>
</window>
```

Here, a syntax and format are illustrated for directing a client 500 to include event properties information in a message to an identified RCP 200. The client 500 is directed to generate and send the message in response to a detected identified event. When an event, e.g., mousedown or a mousemove, is detected, several mouse-position related properties can be accessed by the client 500. A “properties” attribute can be defined allowing a resource to direct a receiving client 500 to include one or more property values associated with a detected event in the message to the identified RCP 200. The mouse pointer position where a mousedown event occurred on a presented page of a resource can be identified by defining names for a horizontal position and a vertical position. For instance, the horizontal position can be named “clientX” and the vertical position can be named “clientY”. The values of these properties can be identified for sending to the identified RCP 200 by including their names in a “properties” attribute. Those skilled in the art will understand that other coordinate systems, property names, syntax, and formats are suitable for identifying event properties.

In another aspect, a markup language specification can be created specifying event elements in an event markup language. An event markup language can be included in a resource along with one or more elements from one or more markup languages. An event markup language allows event detection and handling to be kept separate from markup languages designed for other purposes, such as content. This is similar to the use of CSS for specifying presentation attributes for markup languages that specify structure, such as HTML.

Multiple event markup languages can be defined each supporting a different event model. Alternatively or additionally, an event markup language can be specified and associated with a separately specified event model. The association can be provided through an attribute element in the event markup language that accepts an identifier, such as a URI, of an event model specification. This arrangement allows a markup language based resource including an event element to support different event models based on the setting of the event model attribute.

According to aspects discussed above, the view generator component 230 in the RCP 200 is configured to generate the MLB resource. Alternatively or in addition, the MLB resource can be generated by a resource editor hosted by a device other than the RCP host device 100. For instance, FIG. 8 is a block diagram of an exemplary arrangement for generating an MLB resource according to one aspect. A developer device 800 includes a resource editor 820 configured to generate a resource using a markup language. As the resource editor 820 constructs an MLB resource, a model of the resource, including its content, if any, is managed by a content model 850, e.g., a DOM. The resource editor 820 and the content model 850 operate within an execution environment 810 provided by a developer device 800. In one aspect, the execution environment 810 can provide a communication subsystem (not shown) for allowing a generated MLB resource to be transmitted to a device, such as the RCP host device 100 via the network 20.

According to an aspect, the resource editor 820 can be configured with a schema of a markup language. The schema can be defined to include in the markup language an element defined for identifying an event. An event element can identify an event defined in an event model. The event model can be associated with a resource based on the markup language. The resource editor 820 can use the schema to determine whether an element, such as the event element, is valid. When it is valid, the resource editor 820 can allow the markup language element to be included in the resource maintained by the content model 850. A user can enter the markup language editor directly or use controls provided by the resource editor 820 to include an “<event/>” tag or an analog, for example, in the resource.

The markup language element defined for identifying an event can be included using a pre-generated resource 830 that includes the markup language element 832. Alternatively or in addition, an “<event/>” element or analog can be included as a markup language template element 842 in a template 840.

In one aspect, the resource editor 820 can include an output manager 860 configured for providing the generated MLB resource to the RCP 200 or to the client 500. The output manager 860, in one aspect, can be configured to store the generated MLB resource in a storage location accessible by an RCP host device 100. Additionally or alternatively, the output manager 860 can be configured to transmit the generated MLB resource to the RCP 200 via the network 20. In one aspect, the RCP 200 can receive or retrieve the generated MLB resource and store it in the database 140 as a preconfigured resource 150.

Referring again to FIG. 1 and FIG. 2, the view generator component 230 can provide the MLB resource, in an aspect, to the client 500 by calling an output router component 240 that can be included in the arrangement 200 for a message to send to the client 500. The RCP 200 can include one or more output routers 240 for generating one or more message types for sending to the client 500 via one or more protocols. For example, the output router 240 can be configured to interoperate with an HTTP application layer 114 to generate and send the MLB resource in an HTTP response message to the client 500. This is a typical response message when the input router component 210 receives an HTTP command.

Alternatively, the output router component 240 can interoperate with a publish-subscribe application layer 114, e.g., an XMPP-IM layer, to generate and send a notification message including the MLB resource by value and/or by reference to the client 500. The message including the resource can be sent in an asynchronous message to the client 500. The client 500 can have a subscription for receiving the asynchronous message or the message can be sent to the client 500 unsolicited without a subscription.

Referring again to FIG. 3, the exemplary method continues when an indication is received that the identified event is detected in association with presenting the resource at the client 500 (block 302). An exemplary system for carrying out the method includes means for receiving the indication that the identified event is detected in association with presenting the resource at the client 500. For example, the input router component 210 in the RCP 200 can be configured for performing this function.

According to one aspect, the indication of the detection of the identified event is included in a message from the client 500 and transmitted over the network 20. The message is received by the network stack 112 in the execution environment 110 of the RCP host device 100. The message is processed by the various layers of the network stack 112 and provided to an application layer 114, which processes any application specific data, such as a header and/or a trailer. As stated above, the application layer 114 can support various communication protocols, such as request-response and publish-subscribe communication protocols. Thus, in one aspect, the message can be an HTTP request message and in another aspect, the message can be a publish-subscribe message, such as a subscribe or publish message.

Once processed by the application layer component 114, the message can be passed to the input router component 210. Alternatively, the message can be provided directly from the network stack 112 to the input router component 210 of the RCP 200. In one aspect, the message can include information identifying at least a portion of the MLB resource associated with the detected event, a session identifier for a session between the client 500 and the RCP 200, information identifying a location in the MLB resource associated with the detected event, an update content identifier, and other information that can affect the operation of the RCP 200. The input router component 210 can receive and route the message and/or information received with the message to the event handler component 220 configured to process the indication of the identified event. For example, when the message includes a subscription request, the input router component 210 can route the indication to the pub-sub event handler 220a depicted in FIG. 4 for processing.

Referring again to FIG. 3, in response to receiving the indication included in the message, the exemplary method includes providing for the identified RCP 200 to provide update content for the updatable portion of the resource (block 304). An exemplary system for carrying out the method includes means for providing for the identified RCP 200 to provide update content. For example, the event handler component 220 can be configured to perform this function.

In one aspect, the event handler component 220 receives the message from the input router component 210 and is configured to identify the update content identifier in the message. The event handler component 220 can provide the update content identifier to the view generator component 230, which can retrieve the update content based on the content identifier. Alternatively, the event handler 220 can call the data model 120 providing information based on the received message, such as the event indicator, occurrence portion information, update portion information, parameters included in the message, information about the sender of the message determined from the message and/or the network connection over which the message was received. The data model 120 can generate data and/or retrieve data stored in the RCP database 122. The data model 120 can return the generated and/or retrieved data to the event handler 220 for use in determining and/or generating the update content for the updatable portion of the MLB resource associated with the received indication.

Alternatively, in another aspect where the received message is a publish-subscribe message, the pub-sub event handler 220a, depicted in FIG. 4, is configured to receive the message from the input router component 210. In this aspect, a subscribe message and a publish message can include the event indicator. The reception of a pub-sub message including an indication of the event can cause the subscription handler 222 or the publication handler 224, depending on the type of the received message, to call the view generator component 230 for generating update content for the updatable portion of the presented MLB resource.

According to an aspect, the event handler component 220 can provide data provided by the data model 120, determined by the event handler 220, and/or derived from message information based on the indication to the view generator 230 depending on the specific message received and the configuration of the event handler 220 invoked to process the message. The view generator component 230 can be configured to generate the update content based on the data provided by the event handler 220.

In one aspect, the view generator 230 can retrieve a preconfigured update content 160 and/or an update content template 162 based on the information, e.g., the update content identifier, provided by the event handler 220. The preconfigured update content 160 and update content templates 162 can be stored in the database 140, and the view generator 230 can retrieve preconfigured content 160 and templates 162 by invoking the resource manager 130.

In one aspect, preconfigured update content 160 can include an event element that identifies one or more events defined in the event model associated with at least a portion of the resource. Alternatively or additionally, the view generator component 230 can provide for including the event element in the update content that is generated based on the preconfigured content. Similarly, a content template 162 can include a preconfigured event element and/or the view generator 230 can provide for including an event element in the update content generated based on the template 162 in a manner analogous to the generation of the MLB resource described above.

In one aspect, the update content can include information identifying an RCP 200 for providing additional update content. The identifying information can be preconfigured in the preconfigured update content 160 or in the content template 162, or can be included in the generated update content as a result of processing by the view generator component 230. Alternatively, the update content can be empty. In this case, the empty update content can be defined to indicate that the updatable portion of the MLB resource is to be deleted.

In one aspect, the view generator component 230 can provide the update content to the client 500 by calling the output router component 240. As stated above, the output router component 240 is configured to support a variety of communication protocols. For example, the output router component 240 can be configured to interoperate with an HTTP application layer 114 to generate and send the update content in an HTTP response message to the client 500. This is a typical response message when the input router component 210 receives an HTTP command.

Alternatively, the output router component 240 can interoperate with a publish-subscribe application layer 114, e.g., an XMPP-IM layer, to generate and send a notification message including the update content by value and/or by reference to the client 500. The message including the update content can be sent in an asynchronous message to the client 500. The client 500 can have a subscription for receiving the asynchronous message or the message can be sent to the client 500 unsolicited without a subscription.

Following are exemplary messages including update content that can be provided for by the event handler component 220 corresponding to the MLB resources and resource portions illustrated in Examples 1-3 above. The first example, below, is a portion of a message sent to the client 500 including update content for an updatable portion of the resource depicted in Example 1 above. The message includes an operation identifier with a value of “replace” for directing the client 500 to replace the updatable portion of the resource with update content included in the message.

Example Update 1A

Operation: replace
.
.
.
Update Content:
<p>Hello world again!</p>

The operation identifier can be included in a message header, such as a content header in an HTTP response, or can be included in a portion of the message payload, such as a text portion of a multipart MIME payload. In Example 1, the RCP 200 is configured to allow the client 500 to determine the updatable portion of the resource.

Example Update Message 1B below illustrates a portion of a message sent to the client 500 by the output router 240 including update content for the updatable “<p>” element portion of the resource depicted in Example 1. The message includes the operation identifier with a value of “replace” as described in Example Update Message 1A. The “<p>” element in Example Update 1B includes an “eid” attribute with a value set to a predefined keyword “null”. The null value can be predefined to direct the client 500 that the element is not an event element and thus the client is directed not to provide an indication of any events associated with a presented representation of the “<p>” element included in a presentation of the updated resource as a page.

Example Update 1B

Operation: replace
.
.
.
Update Content:
<p eid=“null”>Hello world again!</p>

Example Update Message 2A below illustrates a portion of a message including update content sent to the client 500 by the output router 240 where the updatable portion of the resource is identified by the RCP 200 via a “location” attribute. In Example 2 above, an “<event>” element includes an “id” attribute with a value “e1” for identifying the element. The RCP 200 includes the id in a message including update content for providing a location to the client 500 for performing an identified operation in the resource with the update content. In Example Update 2A, the identified operation is “replace”. The updatable content to be replaced is indicated by a “location” attribute. The location indicated is the element with an id value of “e1”. Example update 2A includes update content including an “<event>” element including content for replacing the “<event>” element associated with the current presentation of the resource.

```
Operation: replace
Location: id=e1
.
.
.
Update Content:
  <event id=“e1” eid=“onClick” rcp=“soap://helloWorld/body2” >
    <body>
    <p>Hello world again!</p>
    </body>
  </event>
```

Example Update Message 2B below illustrates a portion of a message including update content instructing the client 500 to insert the included update content, a “<p>” element after an element with an id attribute with a value of “p1” in the resource as currently presented. The new “<p>” element is generated by the view generator 230 from an update template 162 with a variable where the time is displayed. The event handler 220 determines the time and template id. The view generator 230 receives the template id and time from the event handler 220. The view generator 230 retrieves the identified update template 162 and processes the update template 162 filling in the variable with the time provided.

Example Update Message 2B

Operation: insertAfter
Location: id=p1
.
.
.
Update Content:
<p id=“p2”>It's 5:13pm EDT</p>

Example Update Message 3A illustrates a portion of a message including update content associated with the resource in Example 3. Example update 3A illustrates a message including a combination of operations, “delete” and “insertAfter”. The message directs the client 500 to delete the “<event>” element. Because there is only one “<event>” element in the resource in Example 3, the instruction is unambiguous. The message then directs the client 500 to insert update content included in the message after the “<head>” element. The “<head>” element is also unambiguous since there is only one such element in the resource. In Example Update 3A the combination operation is effectively a “replace” operation. Note the update content provides a new RCP 200 and a new event to be detected.

Example Update Message 3A

```
Operation: delete
Location: <event>
Operation: insertAfter
Location: <head>
.
.
.
Update Content:
  <event eid=“onClick” rcp=“soap://helloWorld/body2” >
  <body>
    <p>Hello world again!</p>
  </body>
  </event>
```

Example Update Message 3B illustrates a portion of a message including update content associated with the resource in Example 3. The operation depicted is an “add” operation. The location element directs the client 500 to add the update content included in the message as content of the “<body>” element. A client 500 can be configured to prepend, append, and/or randomly include the new content in the existing content. An operation in a message including update content can include one or more parameters or modifiers. For example, the add operation can be associated with a “where” parameter that can take a value including “prepend” and “append”.

Example Update Message 3B

Operation=add
Location=<body>
.
.
.
Update Content:
<p>It's 5:13pm EDT</p>

According to the aspects described, update content can be provided by an RCP 200 for replacing the “<event>” portion of the resource. The new “<event>” portion can have different attributes and values because the event element is updatable. An event element and its contents can even be replaced with content that includes no “<event>” element making the presented portion of the associated resource unresponsive to events.

In the aspects described above, the update content is provided to the client 500 in a message sent from the RCP 200 to the client 500 over the network 20. According to an alternative aspect, the RCP 200 can maintain a data model for each client 500. In response to receiving the indication, the event handler component 220 can be configured to update the data model for the particular client 500. The output router component 240 can be configured to initiate a synchronization operation with the corresponding data model of the client 500 to bring the client data model into synchronization with the RCP data model. When the synchronization process ends, the client 500 can be configured to update the presentation of the corresponding resource.

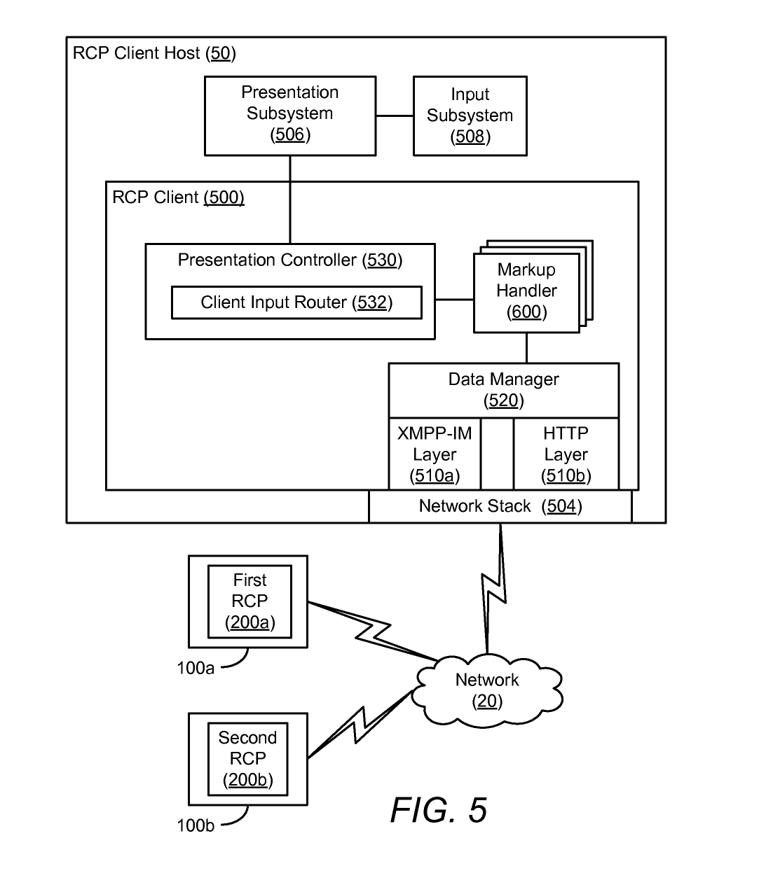

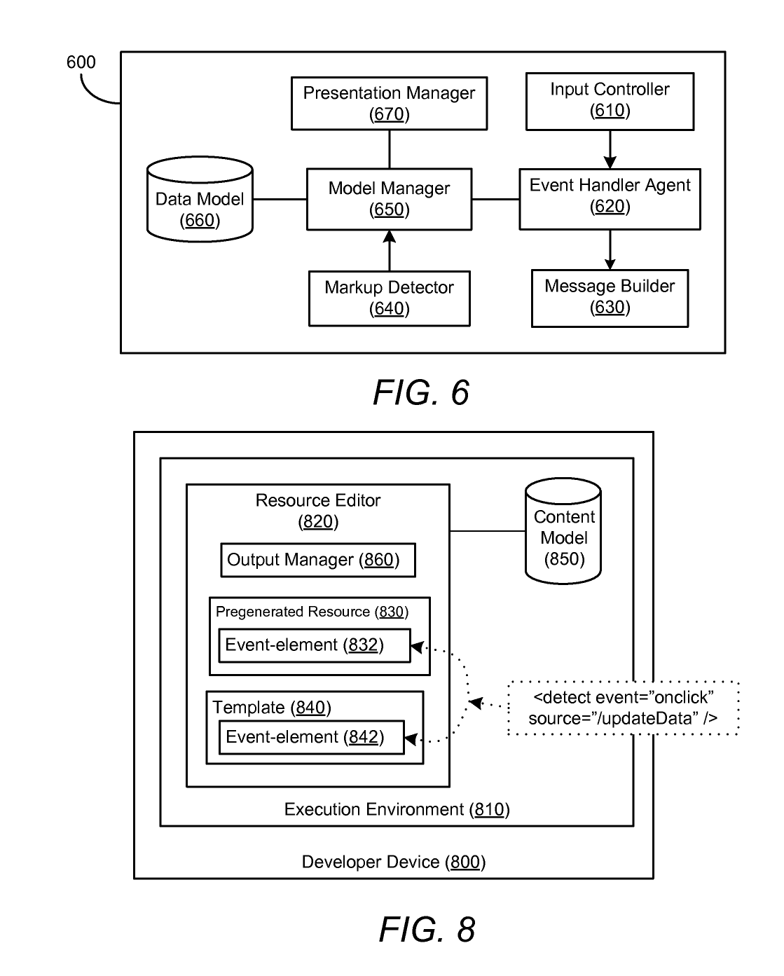

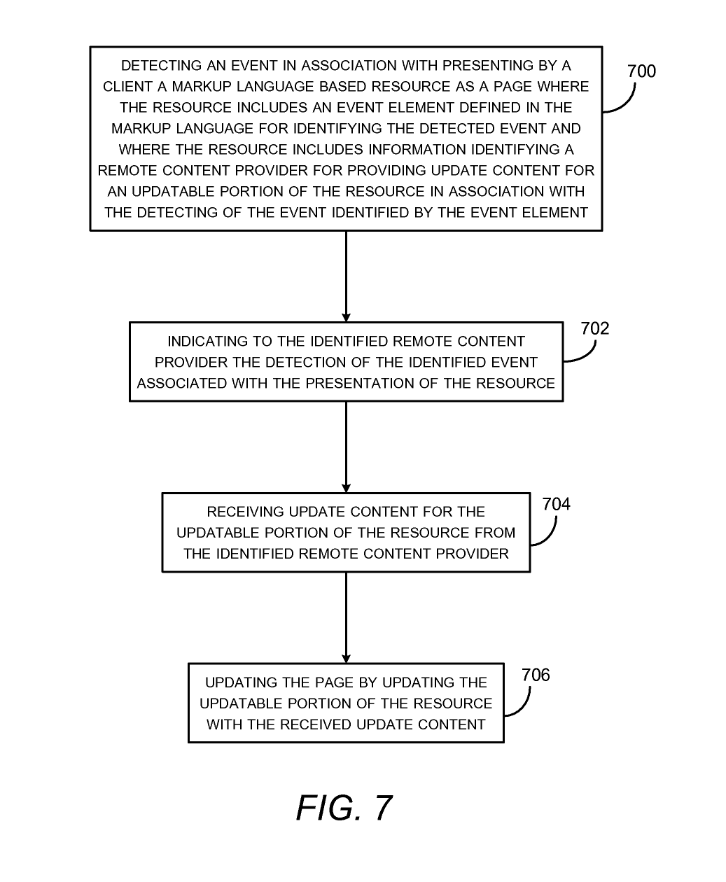

To describe more fully the functionality of the RCP client 500, reference to FIG. 5, FIG. 6 and FIG. 7 is made. FIG. 5 is a block diagram illustrating an exemplary system for dynamically updating content in an MLB resource according to one aspect, FIG. 6 is a block diagram of an exemplary markup handler component according to an aspect, and FIG. 7 is a flowchart illustrating an exemplary method for dynamically updating content in the MLB resource according to one aspect.

According to the exemplary method depicted in FIG. 7, the process begins when an event is detected in association with presenting by the RCP client 500 an MLB resource as a page where the resource includes an event element defined in the markup language for identifying the detected event and where the resource includes information identifying a remote content provider 200 for providing update content for an updatable portion of the resource in association with the detecting of the event identified by the event element (block 700). An exemplary system for carrying out the method means for detecting the event in association with presenting the MLB resource as a page. For example, the RCP client 500 can include an input controller component 610 configured to perform this function.

In one aspect, shown in FIG. 5, the RCP client 500 operates in an execution environment of a device depicted as an RCP client host 502. The RCP client 500 can be, as depicted in FIG. 5, an application, such as web browser, for accessing and presenting resources from one or more remote content providers 200, such as a first RCP 200a and a second RCP 200b. A resource from an RCP 200 can be received via the network 20 by a network stack 504 operatively coupled to the network 20. The network stack 504 can be configured to process message headers and trailers and pass the message payload to an application protocol layer such as an HTTP layer 510b, an XMPP-IM layer 510a, or another application layer (not shown). Alternatively or additionally, the network stack 504 can be configured to provide the message payload to a data manager 520 included in the RCP client 500.

When the resource is included in an application protocol message, a compatible application layer component 510a, 510b processes the application protocol message and provides the resource to the data manager 520. The data manager 520 can be configured to provide the resource to a compatible markup handler 600. In one aspect, the RCP client 500 can be configured to present resources based on multiple data types including multiple markup language based data types. Thus, the RCP client 500 can include multiple markup handlers 600. In one aspect, a single resource can include portions where the data type differs for multiple portions. The data manager 520 can be configured to provide each of the various portions to a compatible markup handler 600 based on each portion's data type.

Referring now to FIG. 6, an exemplary markup handler 600 includes a markup detector component 640, a model manager component 650 and a presentation manager component 670. In one aspect, the markup detector component 640 is configured to parse the resource based on markup elements included in the resource. Some markup detectors 640 can be configured to validate a markup portion of the received resource data based on, for example, a specified schema associated with elements of a markup language included in the resource. The markup detector 640 provides the parsed resource to the model manager 650. The model manager 650 causes the presentation manager 670 to present the resource as interpreted by the model manager 650. Some model managers 650 can be configured to maintain a data model 660 of the received resource for use in updating the presentation. The data of the model 660 is stored in a data model data store. Alternatively or additionally an RCP 200 can configured to maintain the data model corresponding to the resource.

When directed to present at least a portion of the resource, the presentation manager 670 calls a presentation controller 530 (FIG. 5) configured to manage a user interface provided for the RCP client 500. The presentation controller 530 can be configured to allocate a presentation space provided by a presentation subsystem 506 among one or more markup handlers 600 for storing a presentable representation of a resource based on multiple data types. The presentation controller 530 interoperates with the presentation subsystem 506 to present the resource via a presentation device (not shown), such as a display, as directed by the presentation manager 670 and the presentation controller 530 based on the capabilities provided by the execution environment in general and the presentation subsystem 506 in particular. An exemplary presentation subsystem 506 includes a GUI manager providing a library of widgets and drawing routines for use by the RCP client 500, a display driver providing a software interface and resources for controlling a display by the GUI manager, and the display for presenting the presentable representation of the resource as a page on the display.

According to one aspect, while the MLB resource is presented as a page, input information identifying an event associated with an input, such as user provided input, can be detected by an input subsystem 508 included in the client host 502. The received input can be the result of an input indication from an input device (not shown), such as a mouse, key, button, toggle, pointing, or selection control. The input subsystem 508 can be configured to detect input from one or more hardware input controls via an input driver associated with each hardware control.

In one aspect, the input subsystem 508 can route the indication to a component of the presentation subsystem 506, such as a GUI manager. The presentation subsystem 506 can determine an application or other executable in the execution environment associated with the input. For example, an input received when the resource presented as a page by the client 500 has focus on the display is associated with the owner of the presented page, the client 500. Alternatively, an input control can be reserved for use by the client 500, so that an input indication detected from the reserved control is provided to the client 500 as input information. The input information can be provided to the client 500 by the input subsystem 508 via the presentation subsystem 506, or the input subsystem 508 can provide the input information to the client 500 directly.

In one aspect, the client 500 receives input information via the presentation controller 530, which includes an input router 532 configured to receive the input information. Based on information received from the presentation controller 530, the client input router 532 determines a markup handler 600 configured for processing the input associated with the markup language included in the presented resource. For example, if the resource is a JPEG image including RDF markup, the client input router 532 can route the detected input indication to a markup handler 600 configured for processing JPEG formatted data including metadata. The JPEG markup handler 600 can call an RDF compatible markup handler 600. Alternatively, the client input router 532 can be configured to invoke the RDF markup handler 600 directly. If the resource is an HTML based resource, the client input router 532 can be configured to invoke an HTML markup handler 600.

According to an aspect, the input controller component 610 included in the markup handler 600 is configured to receive the input information associated with the detected input, and to detect an event based on the input information received in association with presenting the resource as a page. In one aspect, the input controller 610 can be configured to route a command and/or the received input information based on the detected input information. For example, based on the identified event detected, the input controller 602 can be configured to call a corresponding event handler agent 620 for processing the detected event.

In one aspect, the event handler agent 620 interoperates with the model manager 650 to determine that the event element is included in the resource and to receive an identifier of the RCP 200 for providing update content. In one aspect, the event element in the resource directs the event handler agent 620 to provide an indicator of the detection of the event to the RCP 200 identified in the resource. Based on information received by the event handler agent 620 from the input controller 610 and/or the model manager 650, the event handler agent 620 provides message information to a message builder 630 where the message information includes an indicator of the detection of the identified event and information identifying and enabling access to the RCP 200.

For example, suppose the MLB resource represented by Example 1 is received and presented as a page by the RCP client 500. In this example, the “<p>” element, also referred to as a paragraph element, is specified as identifying an “onClick” event. The provider of the resource is defined as the RCP 200 for providing update content.

When the resource is presented by the presentation subsystem 506, a mouse click is detected by a mouse input device where the mouse pointer is presented in association with the presented paragraph. The mouse input device sends an input indication to the input subsystem 508, which provides indication information to the presentation subsystem 506 for determining an application for handling input information associated with the input event.

Based on the position of the mouse pointer in relation to the presented paragraph, the presentation subsystem 506 determines the RCP client 500 as the application associated with the event. The presentation subsystem 506 provides input information including, for example, the mouse pointer position and the widget presenting the page associated with the input. The client input router 532 receives the input information from the presentation subsystem 506 for the RCP client 500. Based on the input information, the client input router 532 determines a markup handler 600 for processing the event. The event handler agent 620 determines the event element associated with the “onClick” event based on the input information and the data model 660 and determines that the RCP 200 for update content is the provider of the resource based on the configured default.

Referring again to FIG. 7, when the identified event is detected, the exemplary method continues by indicating to the identified RCP 200 the detection of the identified event associated with the presentation of the resource (block 702). An exemplary system for carrying out the method includes means for indicating the detection of the identified event to the identified RCP 200. For example, the message builder component 630 can be configured to perform this function.

According to an aspect, the event handler agent 620 interoperating with the model manager 650 determines event information for including in a message to be sent to the identified RCP 200. The event information can include an identifier of the event for indicating the detection of the event. In some aspects, the event information can also include user data, client 500 data, and/or any data accessible by the RCP client 500 in an execution environment hosting the RCP client 500. The event information can include, in one aspect, location information for indicating an updatable portion of, and/or a position in, the resource associated with the detected event. The location information can be in the form of an “id” attribute, an XPath expression, or in any form suitable for identifying the updatable portion.

In one aspect, a first portion of the resource can be associated with an event as a portion associated with the occurrence of the event, and a second portion can be associated with the event as a portion associated with update content in response to the detection of an event. The first portion or the second portion can be associated with both the occurrence of the event and the update content, and/or multiple portions can be associated with an event as update portions.

According to one aspect, the message builder 630 can be configured to call the data manager 520 for generating a message based on the event information provided by the message builder 630 to the data manager 520. The message builder 630 and/or the data manager 520 determine the protocol and message format required for accessing the identified RCP 200. In one aspect, the data manager 520 generates a message addressed to the identified RCP 200 based on the determined protocol. The generated message is compatible with the XMPP-IM layer 510a or the HTTP layer 510b or a layer of the network stack 504, or another layer as configured for the client 500. The protocols listed are exemplary and are not meant to provide an exhaustive list.

The data manager 520 provides the generated message including information for indicating to the identified RCP 200 the detection of the identified event where the detected event is detected in association with presenting the page including a representation of the resource. The message is sent via one of the application layers 510a, 510b and the network stack 504 over the network 20. The identified RCP 200 to which the message is sent can be the provider of the presented resource, e.g., the first RCP 200a, or another RCP, depicted as the second RCP 200b.

According to an aspect, an indication can be provided to one RCP 200 or more by the message builder 630. The message can be a synchronous message such as an HTTP message. Alternatively, the message can include a subscription for receiving update content via an asynchronous message from one or more RCPs 200 or in a notification to a watcher component included in the identified RCP 200.

For example, referring again to the resource represented by Example 1, the message builder 630 can be configured to provide an indicator, in the form of a message for example, in a number of formats and including various pieces of available information. The message can include an indicator that the request is for update content. The indicator can be provided in a message header, in a parameter in a URI included in the message, and/or in the payload of the message. Alternatively or additionally, the message can include an identifier of the event, location/position information, operation information, and/or any other attribute information associated with the event element. In one aspect, any information available to the message builder 630 can be included in the message depending on the configuration of the client 500. For example, the message can include a client identifier, execution environment information such as the operating system type and version, and/or user information. In Example 1, the indicator is provided to the identified RCP 200, http://www.example.com indicated as the default in Example 1.

For the resource represented by the markup language depicted in Example 3, the indication is provided to the RCP specified by the “rcp” attribute, “pub-sub://helloWorld@no.us/body”. The message builder 630 directs an indication of the detection of the identified event to the RCP, “pub-sub://helloWorld@no.net/body,” as specified by the “rcp” attribute. The message builder 630 then sets a timer according to the “altTimer” attribute. If the timer expires before the reception of the first indication is confirmed, the message builder 630 provides a second indication based on the value of the “altrcp” attribute.

Once the detection of the identified event is indicated to the identified RCP 200, the exemplary method continues when update content is received for the updatable portion of the resource from the identified RCP 200 (block 704). An exemplary system for carrying out the method includes means for receiving update content for the updatable portion of the resource from the identified RCP 500. For example, the markup detector component 640 in the markup handler component 600 can be configured for performing this function.

According to an aspect, the markup handler 600 can be configured to process markup of a specified resource type including a markup based portion. Examples of resource types that can include markup include images, e.g., images in JPEG format, audio and/or video streams, e.g., MPEG formatted audio and/or video, HTML and HTML variants, and all XML based resources such as XHTML, RDF, and XMPP-IM. Update content can include one or more sub-portions based on one or more markup languages or can be free of any markup language elements. The update content can be processed by a single markup handler 600 compatible with the markup included in the resource or can be processed by multiple markup handlers 600 based on markup elements from multiple markup languages.

In one aspect, the markup detector component 640 in the markup handler 600 receives the update content and parses at least a portion of the update content. The markup detector component 640 can then provide at least the parsed portion of the update content to the model manager 650 for further processing. Alternatively, the markup detector component 640 can be configured to update the data model 660 based on markup elements and element content detected as a result of parsing at least a portion of the update content.

Referring again to FIG. 7, when the update content is received, the page is updated by updating the updatable portion of the resource with the received update content (block 706). An exemplary system for carrying out the method includes means for updating the page by updating the updatable portion of the resource with the received update content. For example, the model manager component 650 can be configured to perform this function.

In one aspect, the model manager component 650 is configured for updating the presented page associated with the MLB resource. The model manager component 650 can identify a data model 660 associated with the MLB resource and then identify a portion of the data model 660 corresponding to the updatable portion of the resource. The model manager 650 can receive the update content parsed by the markup detector component 640, and update the identified updatable portion of the presented MLB resource as represented in the data model 660 with on the update content. For example, the updatable portion can be replaced, or deleted, or the update content can be inserted in a location associated with the identified updatable content. The presentation manager 670 can be called to update the page by updating a presentable representation of at least an updated portion of the resource as represented in the data model 660 updated with the update content.

The presentation manager 670, in one aspect, causes the presentation controller 530 to update a portion of the page including a presentable representation of the resource. The presentation controller 530 can include a widget handler (not shown) associated with the page or alternatively the markup handler 600 can include the widget handler and the presentation controller 530 provides access to the presentation subsystem 506. In either alternative, the widget handler for the page calls the presentation subsystem 506 to update the presentation of the page based on the updated resource stored in the data model 660. For example, the page widget handler can cause a GUI manager included in the presentation subsystem 506 to redraw at least an updated portion of the presented representation of the resource. The GUI manager interoperating with a display driver stores the updated portion in a display buffer, which then can provide its contents to the display along with location information allowing the display to update a portion of the display region associated with the updated portion of the presented page.

According to the aspects described above, the update content is received in a message from the identified RCP 200, and then processed by the markup detector component 640 and the model manager component 650 to update the page with the received update content. In another aspect mentioned above, the update content is received via a synchronization operation with the identified RCP 200. In this aspect, the data model 660 associated with the resource is synchronized with a data model 120 (FIG. 1) maintained by the RCP 200. In this manner, the data model 660 is updated with the update content. When the synchronization operation of the data model 660 is completed, the presentation manager component 670 is called to refresh the presentation of the page using the updated data model 660.

Through aspects of the aspects described, dynamic web content can be supported without the use of client-side scripting thereby creating a more secure browsing environment. Moreover, web content creators, who are often not programmers, can create web interfaces without writing scripts. In other words, user interface development can be separated from the logic that drives the dynamic aspects of the user interface. It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both.

Moreover, executable instructions of a computer program for carrying out the methods described herein can be embodied in any machine or computer readable medium for use by or in connection with an instruction execution machine, system, apparatus, or device, such as a computer-based or processor-containing machine, system, apparatus, or device, that can read or fetch the instructions from the machine or computer readable medium and execute the instructions.

As used here, a “computer readable medium” can be any medium that can contain, store, communicate, propagate, or transport the computer program for use by or in connection with the instruction execution machine, system, apparatus, or device. The computer readable medium can be, for example, but not limited to, an electronic, magnetic, optical, electromagnetic, infrared, or semiconductor machine, system, apparatus, device, or propagation medium. More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), (g), or (n) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

Thus, the subject matter described herein can be embodied in many different forms, and all such forms are contemplated to be within the scope of what is claimed. It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for providing updated content in a markup language based resource, the method comprising:
providing to a client a markup language based resource including an event element defined in the markup language for identifying an event and including information identifying a remote content provider for providing update content for an updatable portion of the resource, the event element for directing the client to detect the identified event at the client in association with presenting the resource as a page by the client;
receiving an indication that the identified event is detected in association with presenting the resource at the client; and
providing for the identified remote content provider to provide update content for the updatable portion of the resource in response to receiving the indication.

2. The method of claim 1 further including generating the resource including the event element based on at least one of a preconfigured resource and a resource template associated with the resource, wherein the event element identifies one or more events defined in an event model associated with at least a portion of the resource.

3. The method of claim 2 wherein generating the resource includes providing for including the event element in the resource.

4. The method of claim 1 wherein the identified remote content provider is one of a provider of the markup language based resource and a provider of content not including the resource.

5. The method of claim 1 wherein the event element is at least one of a tag associated with a default event identifier identifying a default event and element including an identifier for an event.

6. The method of claim 1 wherein the event element includes an attribute having a value relating to an action to be performed in response to the detection of the identified event associated with the event element.

7. The method of claim 1 wherein at least one of providing the markup language resource and receiving the indication are performed using one of a request-response protocol and a publish-subscribe communication protocol.

8. The method of claim 1 wherein the event element identifies a publish-subscribe protocol associated with the identified event, and wherein receiving the indication includes receiving a publish-subscribe message request when the identified event is detected by the client in association with presenting the resource at the client.

9. The method of claim 1 wherein the indication includes at least one of event information identifying the detected event, information identifying the update content, location information associated with the detected event, and location information associated with the updatable portion of the resource and wherein providing for the identified remote content provider to provide update content includes at least one of locating and generating the update content based on the at least one of the event information identifying the detected event, information identifying the update content, location information associated with the detected event, and location information associated with the updatable portion of the resource.

10. The method of claim 9 wherein generating the update content includes retrieving at least one of a preconfigured update content entity and an update content template.

11. The method of claim 1 further comprising maintaining a data model for the client and wherein providing for the identified remote content provider to provide update content includes updating the data model with the update content and initiating a synchronization operation with the corresponding data model of the client.

12. A system for providing updated content in a markup language based resource, the system comprising:
means for providing to a client a markup language based resource including an event element defined in the markup language for identifying an event and including information identifying a remote content provider for providing update content for an updatable portion of the resource, the event element for directing the client to detect the identified event at the client in association with presenting the resource as a page by the client;
means for receiving an indication that the identified event is detected in association with presenting the resource at the client; and
means for providing for the identified remote content provider to provide update content for the updatable portion of the resource in response to receiving the indication.

13. A system for providing updated content in a markup language based resource, the system comprising:
a view generator component configured for providing to a client a markup language based resource including an event element defined in the markup language for identifying an event and including information identifying a remote content provider for providing update content for an updatable portion of the resource, the event element for directing the client to detect the identified event at the client in association with presenting the resource as a page by the client;
an input router component configured for receiving an indication that the identified event is detected in association with presenting the resource at the client; and
an event handler component configured for providing for the identified remote content provider to provide update content for the updatable portion of the resource in response to receiving the indication.

14. The system of claim 13 wherein the view generator component is configured for generating the resource including the event element based on at least one of a preconfigured resource and a resource template associated with the resource, wherein the event element identifies one or more events defined in an event model associated with at least a portion of the resource.

15. The system of claim 14 wherein the view generator component is configured for providing for including the event element in the resource.

16. The system of claim 13 the identified remote content provider is one of a provider of the markup language based resource and a provider of content not including the resource.

17. The system of claim 13 wherein the event element is at least one of a tag associated with a default event identifier identifying a default event, an extension of hypertext markup language (HTML), and an element defined in a specified markup language.

18. The method of claim 13 wherein the event element includes an attribute having a value relating to an action to be performed in response to the detection of the identified event associated with the event element.

19. The system of claim 13 wherein the input router component is configured for receiving the indication using one of a request-response protocol and a publish-subscribe communication protocol.

20. The system of claim 13 wherein the event element includes a subscription request associated with the identified event, and wherein the input router component is configured for receiving the subscription request when the identified event is detected by the client in association with presenting the resource at the client.

21. The system of claim 13 wherein the indication includes event information identifying the detected event and location information associated with the detected event and with the updatable portion of the resource and wherein the event handler component is configured for at least one of locating and generating the update content based on the event information and location information.

22. The system of claim 21 wherein generating the update content includes invoking the view generator component to retrieve at least one of a preconfigured update content entity and an update content template based on at least one of the event information and the location information.

23. The system of claim 13 further comprising a data model for the client, wherein the event handler component is configured for updating the data model with the update content and for providing for initiating a synchronization operation with the corresponding data model of the client.

24. A computer readable medium embodying a computer program, executable by a machine, for providing updated content in a markup language based resource, the computer program including executable instructions for:
providing to a client a markup language based resource including an event element defined in the markup language for identifying an event and including information identifying a remote content provider for providing update content for an updatable portion of the resource, the event element for directing the client to detect the identified event at the client in association with presenting the resource as a page by the client;
receiving an indication that the identified event is detected in association with presenting the resource at the client; and
providing for the identified remote content provider to provide update content for the updatable portion of the resource in response to receiving the indication.

25. A method for dynamically updating content in a markup language based resource, the method comprising:
detecting an event in association with presenting by a client a markup language based resource as a page where the resource includes an event element defined in the markup language for identifying the detected event and where the resource includes information identifying a remote content provider for providing update content for an updatable portion of the resource in association with the detecting of the event identified by the event element;
indicating to the identified remote content provider the detection of the identified event associated with the presentation of the resource;
receiving update content for the updatable portion of the resource from the identified remote content provider; and
updating the page by updating the updatable portion of the resource with the received update content.
